(19) United States
(12) Patent Application Publication
(10) Pub. No.: US 2026/0148499 A1
(43) Pub. Date: May 28, 2026

(54) DMESH: A DIFFERENTIABLE MESH REPRESENTATION USING WEIGHTED DELAUNAY TRIANGULATION

(71) Applicant: Adobe Inc., San Jose, CA (US)

(72) Inventors: Sanghyun Son, College Park, MD (US); Yi Zhou, San Jose, CA (US); Zexiang Xu, San Jose, CA (US); Yang Zhou, Mountain View, CA (US); Matheus Gadelha, San Jose, CA (US)

(21) Appl. No.: 18/958,151

(22) Filed: Nov. 25, 2024

(51) Int. Cl. G06T 17/20

(52) U.S. Cl. CPC G06T 17/205

(57) ABSTRACT

Disclosed embodiments may provide techniques for generating a differentiable mesh representation of an image object. A computer-implemented method can include accessing a set of points, in which each point is assigned with a weighted value. The method can also include receiving ground-truth input to generate a differentiable mesh representation associated a target object. The method can also include constructing an initial mesh representation of the target object by generating a plurality of simplices based on the weighted values of the points. The method can also include optimizing the initial mesh representation by iteratively adjusting the existence probability values based on a comparison between the initial mesh representation with the ground-truth input. The method can also include extracting the differentiable mesh representation of the target object by selecting a set of simplices of the plurality of simplices associated with the initial mesh representation.

### FIELD

The present disclosure relates generally to generating mesh representation of image objects. In one example, the systems and methods described herein may be used to generate a differentiable mesh representation of image objects based on weighted Delaunay triangulation functions.

### BACKGROUND

Polygonal meshes are widely used in 3D graphic-processing applications such as modeling and animation due to their diverse, compact and explicit configuration. Polygonal meshes can be created by connecting sparse, non-uniformly distributed points with edges. Recent progress in artificial intelligence has spurred efforts to integrate mesh generation into machine learning, but challenges (e.g., varying topology) hinder suitable mesh representations. Such limitation leads to reliance on differentiable intermediates such as existing techniques using implicit functions and subsequent iso-surface extraction for mesh creation. However, existing techniques can result in dense meshes with misalignment issues at sharp edges, necessitating further decimation, potentially introducing additional errors.

The trend of modeling 3D objects as differentiable neural representations has gained popularity in graphics and vision applications, primarily for 3D reconstruction and novel view synthesis, allowing shape optimization through gradient descent and backpropagation. Several existing methods express scene geometry using volume density and differentiable volume rendering. However, these density-based volumetric approaches don't always result in accurate 3D geometry. To improve this, existing techniques model surface functions as neural signed distance functions (SDFs), converting them to density for rendering and optimization. More recently, neural unsigned distance functions (UDFs) have been developed to model open surfaces, which SDFs cannot describe.

### SUMMARY

Disclosed embodiments may provide a differentiable mesh representation that can be generated by using Weighted Delaunay Triangulation (WDT) function. To generate the differentiable mesh representation, a computer-implemented method includes generating a general 3D mesh representation, at which both mesh topology and geometric features (e.g. encoded in vertex location) can be simultaneously optimized through gradient-based techniques. The method uses the WDT function to divide a convex domain into tetrahedra to form a mesh. To create the mesh representation with arbitrary topology, the computer-implemented method includes selecting a subset of triangular faces from the tetrahedra (the “real part”) as part of the differential mesh representation. The other triangular faces (the “imaginary part”) initially support the real part but do not become of the final mesh. To distinguish the real parts from the imaginary parts, the computer-implemented method includes assessing the likelihood of a face being part of the mesh based on weighted points that carry positional and inclusiveness information. Optimization can then be focused on the points' features, using a dual power diagram of WDT to generate the triangular mesh. The likelihood determination facilitates computing geometric losses and rendering losses during gradient-based optimization.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features, embodiments, and advantages of the present disclosure are better understood when the following Detailed Description is read with reference to the accompanying drawings.

FIG. 1 illustrates an example schematic diagram for generating a differentiable mesh representation of an image object, according to some embodiments.

FIG. 2 shows an example computing environment for generating a differentiable mesh representation of an image object, in accordance with some embodiments.

FIG. 3 shows example illustrations of simplices generated using the weighted Delaunay triangulation function, according to some embodiments.

FIG. 4 shows example images that depict existence likelihood of an edge “F” in a differentiable mesh representation, according to some embodiments.

FIG. 5 shows an illustrative example of a process for generating a differentiable mesh representation of an image object, in accordance with some embodiments.

FIG. 6 shows example differentiable mesh representations generated from a ground-truth input depicting a dragon image, according to some embodiments.

FIG. 7 shows a comparison of images between a differentiable mesh representation and other mesh representations generated from point cloud data, according to some embodiments.

FIG. 8 shows a comparison of images 800 between a differentiable mesh representation and other mesh representations generated based on multi-view images, according to some embodiments.

FIG. 9 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

One of the challenges in creating a robust polygonal meshes lies in the discrete and combinatorial nature of meshes. A mesh tessellates the subspace by its vertices, edges and faces. Such structural configuration of a mesh is generally referred to as mesh topology, distinguishing from geometric topology that defines the continuous deformation of Euclidean subspaces. A mesh topology can be usually carefully designed by 3D artists, but it is often viewed merely as a data structure and not as an entity that can be optimized in common gradient-based procedures in machine learning pipelines (for example). Existing techniques focus on optimizing surface features within a pre-determined connectivity, but not the connectivity itself. Consequently, existing techniques simplify the task by using a mesh with a pre-determined topology, modifying the predefined mesh through various operations. Although there have been some advancements optimizing meshes of different geometric topologies using differentiable marching cubes, such existing techniques tend to only produce uniform meshes and struggle with open surfaces due to their reliance on volumetric representation.

In addition, existing techniques have attempted altering local connectivity through remeshing. However, the fundamental geometric topology remains unchanged and is thus subject to the above shortcomings. Learning-based approaches like BSP-Net allow for topological variation, yet their meshing process is not differentiable. Existing differentiable iso-surface extraction techniques have been developed, resulting in high-quality geometry reconstruction of various topology when combined with Neural or discrete Signed Distance Functions (SDFs). Other existing techniques also demonstrate backpropagating gradients from mesh vertices to SDF values using non-differentiable techniques like Marching Cubes. However, the surface extraction methods that rely on SDFs and uniform grids often need high-poly meshes for accurate reconstruction, regardless of the actual surface's complexity. Such existing techniques thus result in prohibitively high computational costs for generating meshes of image objects, even if the image object has a relatively simple shape.

To address the aforementioned deficiencies, the present techniques provide a differentiable mesh representation (alternatively referred to as “DMesh”) that can be generated by using Weighted Delaunay Triangulation (WDT) function. The present techniques can establish a general 3D mesh representation, in which both mesh topology and geometric features (e.g. encoded in vertex location) can be simultaneously optimized through gradient-based techniques. To represent a two-dimensional (2D) or three-dimensional (3D) mesh in a differentiable configuration, the present techniques take into account connectivity information of a given mesh. For example, the present techniques define a likelihood of triangular faces to exist on a tetrahedra that compactly tessellate a domain, in which the likelihood is computed using WDT. In some instances, the present techniques define another likelihood to include the faces in the differentiable mesh representation, by only using a subset of faces on the tetrahedra (while discarding other faces) to represent shapes of various topology other than convex shapes. By combining these two sets of probabilities, the present techniques compute the likelihood of face existence in our mesh for a given set of points. The likelihoods in a differentiable framework enable optimizing a 2D or 3D mesh to fit a target geometry using gradient-based optimization. The present techniques can reconstruct meshes from various types of ground-truth input, including point clouds or multi-view images.

A graphic-processing application accesses a set of points. In some instances, each point identifies a particular location within one or more regions within a three-dimensional (3D) space. Each point is assigned with a weighted value, in which the weighted value indicates a likelihood of whether the point exists within a differentiable mesh representation.

The graphic-processing application receives ground-truth input to generate the differentiable mesh representation associated a target object. As an illustrative example, the graphic-processing application receives a point cloud depicting a rabbit.

The graphic-processing application constructs an initial mesh representation of the target object. In some instances, the graphic-processing application constructs the initial mesh representation by generating a plurality of simplices based on the weighted values of the set of points. In some instances, each simplex of the plurality of simplices is assigned with an existence probability value that represents a likelihood of points of the simplex existing within the differentiable mesh representation. Continuing with the example, the graphic-processing application generates an initial mesh representation of the rabbit, in which the initial mesh representation is formed by a plurality of triangular faces. The initial mesh representation of the rabbit may include uneven surfaces or image artifacts, which can be refined through optimization.

The graphic-processing application optimizes the initial mesh representation by adjusting the existence probability values based on a comparison between the initial mesh representation with the ground-truth input. Continuing with the example, the graphic-processing application optimizes the initial mesh representation of the rabbit by comparing the coarse mesh with the point cloud of the rabbit.

The graphic-processing application extracts a differentiable mesh representation of the target object by selecting a set of simplices of the plurality of simplices associated with the initial mesh representation. In some instances, the set of simplices include adjusted existence probability values that exceed a threshold value. Continuing with the example, the triangular faces having adjusted existence probability values that exceed a threshold value can be selected. The selected triangular faces can be used to form the differentiable mesh representation of the rabbit. In some instances, the optimizing and extracting steps are iteratively performed until the differentiable mesh representation is refined to accurately represent the target object (e.g., the rabbit).

The present techniques thus provide a significant improvement over existing mesh-generating techniques by generating a differentiable mesh representation that is (self-) intersection-free and versatile to accommodate various surface types (e.g., a non-convex shape) for both open surfaces and closed meshes. The differentiable mesh representation additionally defines all the features on the points and allows for defining optimization losses on the faces. Based on such configuration, the present techniques can easily optimize the mesh generation to automatically minimize a given energy function on faces and vertices using gradient-based algorithms. Moreover, to overcome prohibitively large computational cost of the exact formulation (as utilized by existing techniques), the present techniques implement a relaxation technique that computes the face existence likelihoods with a practical computational cost.

DMesh can additionally be used as a component in 2D and 3D generative AI applications. As an illustrative example, the differentiable mesh representation can be generated based on text prompts or sparse multi-view images. The present techniques are advantageous over existing techniques that produce 3D meshes with low quality and over-dense vertices which limits their usage in downstream applications. Applying DMesh in the 3D generation architectures can extraordinarily improve the quality of the mesh representations and the created meshes will be more suitable for downstream applications. Moreover, the 2D mesh can be used for vector graphs learning and generation. Similar text/image to mesh technologies can apply to 2D meshes using DMesh.

### I. Techniques for Generating Differentiable Mesh Representation of Image Objects

### A. Example Implementation

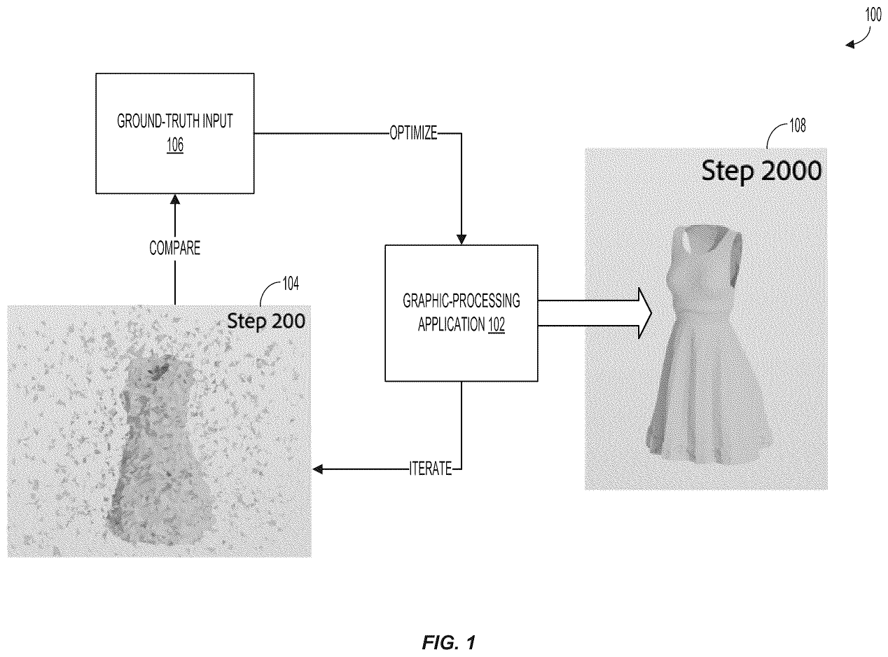

FIG. 1 illustrates an example schematic diagram 100 for generating a differentiable mesh representation of an image object, according to some embodiments. In FIG. 1, a process for generating a differentiable mesh representation of an image depicting a yellow dress is shown. The process begins with a graphic-processing application 102 accessing a set of points, which can be random or sampled from a database. The graphic-processing application 102 assigns each point with a value (e.g., 0.5), in which the value represents the likelihood of the point existing in the mesh representation.

The graphic-processing application 102 receives multi-view images of a yellow dress as ground-truth input 106. The ground-truth input 106 is used to generate a 3D-mesh representation that depict the target object. The graphic-processing application 102 applies a Weighted Delaunay Triangulation (WDT) function to the points to generate an initial mesh representation 104 of the target object. The WDT function creates simplices (e.g., triangular faces) by connecting the points. As shown by the initial mesh representation 104, because the points are randomly placed, many of the resulting triangular faces are likely to be unnecessary or inaccurate.

The graphic-processing application 102 assigns each triangular face an existence probability value that indicates whether its points are likely to form part of the differentiable mesh representation. In particular, triangular faces that align more closely with the shape of the yellow dress receive higher existence probability values, while other triangular faces that do not align with the shape of the yellow dress are assigned lower existence probability values.

The ground-truth application 102 optimizes the initial mesh representation 104 by continuing to compare the initial mesh representation 104 to the ground-truth input 106. The comparison can be performed by using a reconstruction loss to measure the difference between the initial mesh representation 104 to the ground-truth input 106. The reconstruction loss is used to update the probability values of the points. Over multiple iterations, the probability values of the points are updated to minimize the reconstruction loss, to gradually refine the initial mesh representation 104.

As the optimization continues through multiple epochs from “step 200” to “step 200”, the initial mesh representation 104 becomes more refined. Initially, the initial mesh representation 104 does not resemble the yellow dress accurately, but as the process progresses, the graphic-processing application 102 adjusts the triangular faces are adjusted to fit the contours, non-convex shapes, and open-surface details of the yellow dress more closely.

Finally, when the optimization converges, the graphic-processing application 102 produces a differentiable mesh representation 108 that accurately represents the yellow dress provided by the ground-truth input 106. Each simplex (e.g., the triangular face) in the differentiable mesh representation 108 is assigned with a probability value that determines its inclusion in the structure, resulting in a mesh that is highly representative of the original yellow dress image.

### B. Computing Environment

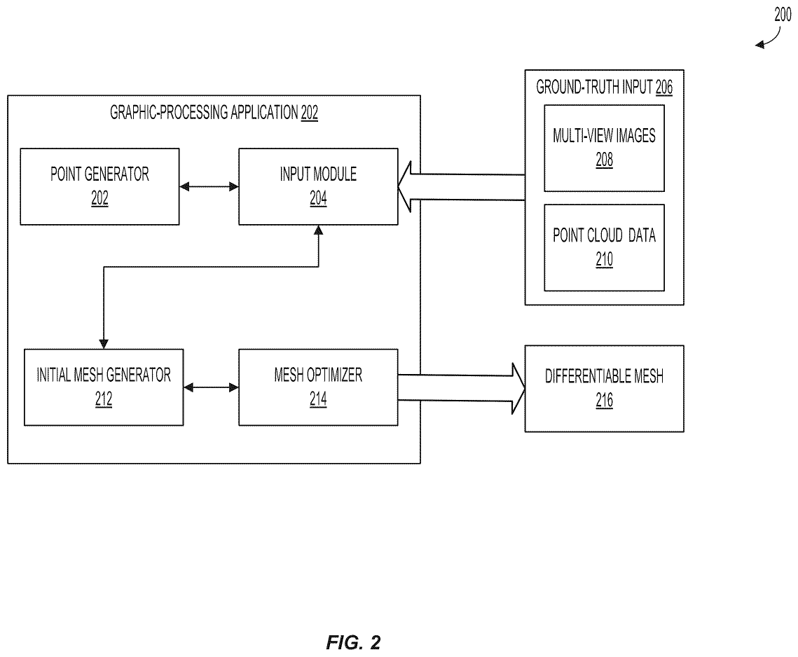

FIG. 2 shows an example computing environment 200 for generating a differentiable mesh representation of an image object, in accordance with some embodiments.

### 1. Point Generator

A point generator 204 of a graphic-processing application 202 accesses a set of points. Each point identifies a particular location within one or more regions (e.g., a grid) within a three-dimensional (3D) space. In some instances, each point is assigned with a weighted value, in which the weighted value indicates a likelihood of whether the point exists within a differentiable mesh representation.

The points can be distributed randomly within the one or more regions, in which the differentiable mesh representation can be generated based on simplices that are formed based on the random distribution of the points. In some instances, points are initialized based on one or more sample points, in which the differentiable mesh representation can be generated based on simplices that are formed based on the sampled distribution. The sampled distribution of points can be advantageous in reducing the computational time and cost for generating the differentiable mesh representation.

### 2. Input Module

An input module 206 of the graphic-processing application 202 receives ground-truth input 206 to generate a differentiable mesh representation associated a target object. In some instances, the differentiable mesh representation corresponds to a two-dimensional or three-dimensional mesh representation of the target object.

In some instances, the ground-truth input 206 includes a set of multi-view images 208 depicting the target object. The set of multi-view images 208 include images captured from different angles or perspectives around the target object. The multi-view images 208 provide a comprehensive visual representation of the target object by showing it from multiple viewpoints, such as front, back, sides, and top. By analyzing how the target object appears from different angles, algorithms can reconstruct its three-dimensional shape and features, thereby improving the precision of the generated mesh representation.

Additionally or alternatively, the ground-truth input 206 includes point cloud data 210 that represents the target object. The point cloud data 210 includes a collection of data points in a 3D coordinate system, in which each point represents a specific location on the surface of the target object. The points of the point cloud data 210 are configured to identify spatial information, such as X, Y, and Z coordinates, that describe the target object's shape and structure. In some instances, additional attributes like color or intensity values may be associated with each point to enhance the level of detail of the mesh representation.

### 3. Initial Mesh Generator

An initial mesh generator 212 of the graphic-processing application 202 constructs an initial mesh representation of the target object. The initial mesh representation is constructed to represent one or more surfaces of the target object and includes a network of interconnected vertices, edges, and simplices. The simplices, typically triangular or quadrilateral, form shape components that define the shape and appearance of the target object. As an illustrative example, the vertices represent points in 3D space, and the edges connect the vertices to form the target object's surface. The mesh representations are thus used to approximate the geometry of target object and is configured to be used for rendering 3D models in simulations, animations, video games, and virtual environments. The mesh representations also allow for efficient storage and manipulation of 3D shapes, enabling detailed visualizations and modifications of the target object's structure.

In some instances, the graphic-processing application 202 constructs the initial mesh representation by generating a plurality of simplices based on the weighted values of the points. In some instances, each simplex of the plurality of simplices is assigned with an existence probability value that represents a likelihood of points of the simplex existing within the differentiable mesh representation.

In some instances, the simplex is a geometric object in any given dimensional space. The simplex is a generalization of certain shapes (e.g., triangles, tetrahedra) to arbitrary dimensions. For example, in a 0-dimensional space, a simplex is a point. In a 1-dimensional space, it is a line segment, which is defined by two points. In a 2-dimensional space, a simplex is a triangle, formed by three points. In a 3-dimensional space, it becomes a tetrahedron, defined by four points. In some instances, the simplex includes one or more faces, which themselves can be simplices of lower dimensions. For instance, the faces of a triangle are its edges, and the faces of a tetrahedron are its triangular faces. Simplices are widely used in computational geometry, particularly in mesh generation and triangulation, in which they serve as fundamental building blocks to divide spaces into smaller, more manageable pieces.

The initial mesh generator 212 generates the plurality of simplices by applying a weighted Delaunay triangulation (WDT) function to the set of points. The following description provides example techniques for using the WDT function to generate the plurality of simplices.

The differentiable mesh is represented as a subset of WDT. For a given set of weighted points [symbol] ∈ [symbol] and their weights [symbol] ∈ [symbol] , we first obtain the WDT from the weighted points, which tessellates the convex hull of the given points into a compact set of d-simplexes. Then, we extract the desirable faces, (d−1)-simplexes from the tessellation. The desirable faces comprise the final meshes of arbitrary topology, which we refer to as “real part”, and the rest of the faces construct the tetrahedralization, and are referred as “imaginary part”.

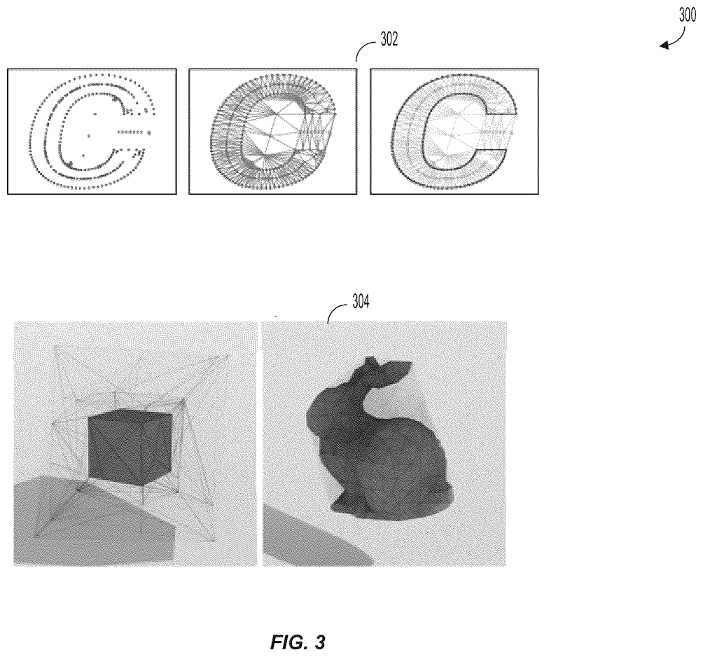

As an illustrative example, FIG. 3 shows example illustrations of simplices 300 generated using the weighted Delaunay triangulation function, according to some embodiments. FIG. 3 illustrates a first set of simplices 302 for d=2 and a second set of simplices 304 for d=3, in which the real faces are rendered in blue and the imaginary in yellow. The first set of simplices 302 represents a letter “C”, in which the initial mesh generator 212: (i) feeds a set of weighted points to WDT (left); (ii) obtains grey triangles (middle); and (iii) extract desirable edges from there (right). As shown in the first set of simplices 302, the edges rendered in blue are “real part” and the yellow ones are “imaginary part” (right). Similarly, the second set of simplices 304 represents a rabbit, in which the blue faces are “real part” and transparent yellow ones are “imaginary part”.

Now let us assume there is a face F that we want to know if it exists in the final mesh or not. Based on the above scheme, we notice that there are two layers of “existence” for F. First, we have to check if F exists in the WDT or not. Formally, we say F∈WDT( [symbol] ) if there is a d-simplex in the tessellation induced by WDT that has F as one of its faces. Second, if F exists in WDT, we have to find out if it is included in the “real part”. Accordingly, we define two predicates, [symbol] and [symbol] to evaluate the existence of F.

a)

[symbol]

First, [symbol] is an inverse WDT function. It tells if the given face F exists in WDT given the weighted point set.

$${𝕀}_{wdt} ( F ) = \{ \begin{matrix}1 & if & F ∈ WDT ( ℙ , 𝕎 ) \\ 0 & else & \end{matrix}$$

As described herein below, a differentiable version for this function, which we denote as Λ_{wdt}(F), is provided.

b)

[symbol]

Regarding the second predicate, [symbol] indicates if F is included in the “real part”.

$${𝕀}_{real} ( F ) = \{ \begin{matrix}1 & if & F lies on the desired surfaces \\ 0 & else & \end{matrix}$$

Although there are various formulations we can use for this predicate, we opt to formulate it by point-wise value η∈{0, 1} for the convenience of inference and optimization. Given a face F=(pᵢ, pⱼ, pₖ) in WDT( [symbol] ), we decide that it lies on the desired mesh if all the three points lie on the mesh. Thus, [symbol] (F) can be defined as:

$${𝕀}_{real} ( F ) min ( {η}_{i} , {η}_{j} , {η}_{k} ) .$$

Note that all of the three points should have a value of 1 to make F to be considered in the “real part”.

As described herein below, a differentiable version for this function, which we denote as Λᵣₑₐₗ(F) is provided.

### c) Face Existence Function

Combining the above two functions, we can define the complete face existence function to determine if a face F exists in the final mesh or not as follows,

$$𝕀 ( F ) = {𝕀}_{wdt} ( F ) ∧ {𝕀}_{dist} ( F ) ,$$

which can be approximated by a differentiable function as follows.

$$𝕀 ( F ) = {Λ}_{wdt} ( F ) \cdot {Λ}_{dist} ( F ) ,$$

### d) Point Features

Note that the face existence functions solely depend on the configuration of the weighted points. Thus, the representation features can be defined on the point set. For example, in our representation, each point is defined as a (d+2)-dimensional vector, d of which represents the spatial position, 1 stands for the weight for WDT, and the remaining 1 is used as η, indicating whether it is in the real part or imaginary part. Note that in our experiments, we set the range of weight to be [0, 1].

### 4. Mesh Optimizer

A mesh optimizer 214 of the graphic-processing application 202 optimizes the initial mesh representation by adjusting the weighted values of the points based on a comparison between the initial mesh representation with the ground-truth input 206. The mesh optimizer 214 can optimize initial mesh representation without accessing volumetric information associated with the ground-truth input 206.

The mesh optimizer 214 optimizes the initial mesh representation by adjusting the existence probability values based on a comparison between the initial mesh representation with the ground-truth input. The graphic-processing application can optimize initial mesh representation without accessing volumetric information associated with the ground-truth input.

To adjust the weighted values, the mesh optimizer 214 determines a reconstruction loss between the initial mesh representation with the ground-truth input. The graphic-processing application modifies the weighted values based on the reconstruction loss. The graphic-processing application then adjusts the existence probability value based on the adjusted weighted values. In some instances, the graphic-processing application utilizes a differentiable existence function allows for adjusting the weighted values. Examples of metrics used for reconstructive loss include Chamfer distance, Hausdorff distance, Mean Squared Error (MSE), Intersection over Union (IoU), and Structural Similarity Index (SSIM).

The mesh optimizer 214 then extracts a differentiable mesh representation 216 of the target object by selecting a set of simplices of the plurality of simplices associated with the initial mesh representation, wherein the set of simplices include adjusted existence probability values that exceed a threshold value. In some instances, the threshold value is selected from one of 0.1, 0.2, 0.3, 0.4, 0.5, 0.6, 0.7, 0.8, 0.9, or 1.0. In some instances, the optimizing and extracting steps are iteratively performed until the differentiable mesh representation is refined to accurately represent the target object.

In some instances, the differentiable mesh representation 216 includes one or more non-convex shapes that represent one or more portions of the target object. Additionally or alternatively, the graphic-processing application 202 extracts the differentiable mesh representation 216 by reducing one or more simplices from the set of simplices of the differentiable mesh representation based on a face-simplification loss function.

The following description describes example techniques for optimizing the initial mesh and extracting the differentiable mesh representation 216.

a) Λ_{wdt}

Λ_{wdt} is a differentiable version of [symbol] . Our formulation leverages the dual structure of WDT, or Power diagram. Note that we develop our theoretical reasoning mainly in 2D, and provide additional explanations for 3D for ease of understanding.

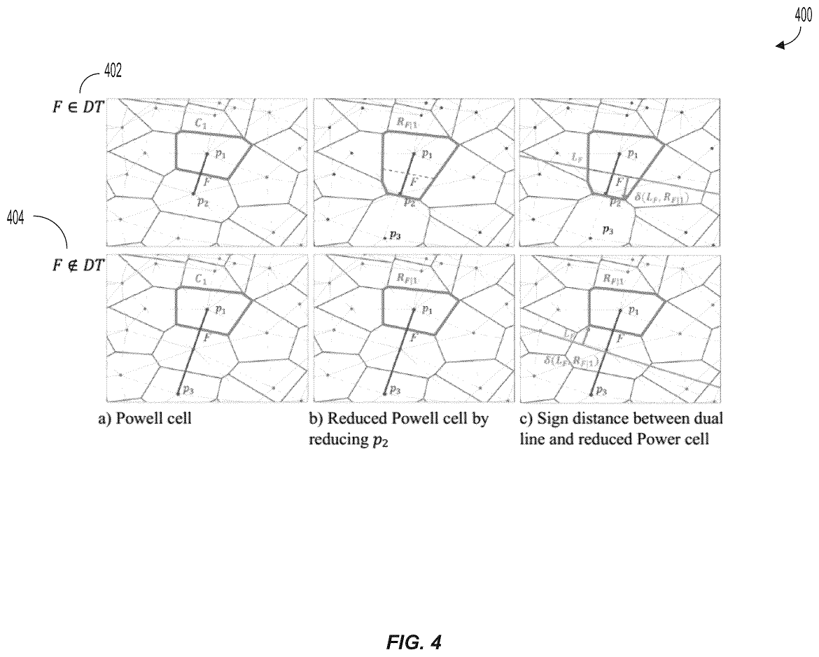

FIG. 4 shows example images 400 that depict existence likelihood of an edge “F” in a differentiable mesh representation, according to some embodiments. Images 402 show a simplex resulting in positive signed distance. Images 404 show another simplex that results in a negative signed distance. As shown in FIG. 4, given a set of points [symbol] ∈ [symbol] and their weights [symbol] ∈ [symbol] , F_{i,j} is the edge between pᵢ and pⱼ, and Cᵢ is the Power cell of pᵢ produced by WDT. Then we denote the dual line of F_{i,j} as L_{F}, which is the intersection of two half spaces defined by pᵢ and pⱼ Note that F_{i,j} exists if and only if the two Power cells Cᵢ and Cᵢ share a common edge, which is a subset of L_{F}. This kind of relationship between the dual line of F and the Power cells can be used to identify the existence of F.

To measure this existence in a differentiable way, we use spatial distance between L_{F} and the corresponding reduced Power cells. Reduced Power cell, denoted as R_{F|i}, is a Power cell of pᵢ when ignoring the other point pⱼ in F.

To define such distance measure, we start with definition of a signed distance between a random point [symbol] ∈ [symbol] and a random (reduced) Power cell R. If we denote d(P, R) as the minimum distance between P and R, which can be computed by projecting P on R, the signed distance ψ₁(P, R) is defined as follows,

$${ψ}_{1} ( R , P ) = d ( P , R ) \cdot {( - 1 )}^{1 - I ( P ∈ R )} ,$$

where I(⋅) is an indicator function. Therefore, ψ₁ gives positive value only when P∈R and negative value when P∉R. Then, based on ψ₁, we can define a signed distance between a line L and R as

$${ψ}_{2} ( L , R ) = {max}_{P ∈ L} {ψ}_{1} ( P , R ) . \qquad ( 1 )$$

Noting that R_{F|i} can exist only when Cᵢ exists, we define the signed distance between the dual line L_{F} and a reduced Power cell R_{F|i} as

$$δ ( {L}_{F} , {R}_{F \vert i} ) = \{ \begin{matrix}{ψ}_{2} ( {L}_{F} , {R}_{F \vert i} ) & if & ∃ {C}_{i} \\ - ∞ & else & \end{matrix} \qquad ( 2 )$$

Then, the following relationship holds,

$$δ ( {L}_{F} , {R}_{F \vert i} ) > 0 ⇔ {𝕀}_{wdt} ( F ) = 1.$$

which means, when F exists in WDT, its dual line has positive signed distance to the reduced Power cell of its two ends, vice versa. FIG. 3 show the cases where F=(p₁, p₂) and F=(p₁, p₃). Note that in the first case, F is an edge in DT, thus δ evaluates to positive value, as L_{F} goes through R_{F|i}. On the contrary, in the second case, F is not an edge in DT and δ becomes negative, as L_{F} is located outside R_{F|i}. Note that this relationship holds for any x∈{i, j}, because the sign of every δ(L_{F}, R_{F|i}) is the same.

Then, coming back to d=3, we define a function

$$Δ ( F ) = \frac{1}{3} ( δ ( {L}_{F} , {R}_{F \vert i} ) + δ ( {L}_{F} , {R}_{F \vert j} ) + δ ( {L}_{F} , {R}_{F \vert k} ) ) . \qquad ( 3 )$$

which satisfies

$$Δ ( F ) > 0 ⇔ {I}_{wdt} ( F ) = 1 .$$

This relationship holds, because the sign of every δ is same as we mentioned above.

Note that this function goes to −∞ if any one of the points in F loses its Power cell. When all of the three points have Power cell, but F does not exists, the function evaluates to a negative value. Finally, it becomes a positive value when F exists. Therefore, we can define a differentiable existence likelihood function for the face F as follows,

$${Λ}_{wdt} ( F ) = σ ( {α}_{face} Δ ( F ) ) , \qquad ( 4 )$$

where σ is a sigmoid function parameterized by α_{face}. In our experiments, we set α_{face}=1000.

Before moving on, we'd like to point out one caveat in this formulation. According to our formulation, there is a possibility where a point loses its Power cell, because its updated weight is relatively smaller than its neighbors. In this case, note that the existence likelihood of a face contained that point before suddenly drops from value larger than 0.5 to 0, and vice versa, which is undesirable. However, in practice, we did not find it a big problem, because in most cases faces that need to exist are updated to increase Eq. 4, which in turn fortifies the existence of Power cells of the points that comprise the face, so that the points are not discarded.

b) Λᵣₑₐₗ

To make [symbol] , the function that tells whether a face is real or imaginary, differentiable, we modify η to have a continuous value in [0, ∞), and use sigmoid function σ(⋅) as follows,

$${Λ}_{real} ( F ) = 1 - σ ( {K}_{real} \cdot ( max ( {η}_{i} , {η}_{j} , {η}_{k} ) - {ϵ}_{real} ) ) ,$$

where Kᵣₑₐₗ and ϵᵣₑₐₗ are constants. We set them as Kᵣₑₐₗ=1000 and ϵᵣₑₐₗ=0.01 in our experiments. Note that η(p) can be interpreted as unsigned distance from the point p to the surface.

### c) Additional Configurations

It is not trivial to compute Eq. 2, especially in 3-dimensional space that we are dealing with. For instance, when Cᵢ exists and we have to evaluate Eq. 1, it is not trivial to find an answer to the optimization problem. Moreover, it is hardly possible to compute every reduced Power cell, R_{F|i,j,k}, for every possible F.

To overcome these computational difficulties, we propose to leverage lower bound of Eq. 2, which can be efficiently found with current Power diagram. To that end, we treat two cases, F∈WDT( [symbol] ) and F∉WDT( [symbol] ), differently. To be specific, when F∈WDT( [symbol] ), we define δ₁ as

$${δ}_{1} ( {L}_{F} , {R}_{F \vert i} ) = {ψ}_{1} ( {P}_{mid} , {R}_{F \vert i} ) \geq 0 , \qquad ( 5 )$$

where P_{mid} is the middle point of the line segment R_{F|i}=L_{F}∩Cᵢ. The existence of P_{mid} is guaranteed, because L_{F} is on the boundary of Cᵢ if F∈WDT( [symbol] ). Note that we can compute Eq. 5 efficiently by projecting P_{mid} to the planes that comprise R_{F|i}, because of convexity. This alone reduces a lot of computational burden, because we only have to gather planes that would possibly comprise R_{F|i}, instead of explicitly constructing it. Also, note that δ₁ is a lower bound of δ by definition at Eq. 1.

When F∉WDT( [symbol] ), we use following δ₂:

$${δ}_{2} ( {L}_{F} , {R}_{F \vert i} ) = {ψ}_{2} ( {L}_{F} , {C}_{i} ) \leq 0. \qquad ( 6 )$$

Note that this is lower bound of δ when F does not exist, because Cᵢ is a subset of R_{F|i}. Since we can readily obtain Cᵢ from current Power diagram, we can compute minimum distances between Lᵢ and line segments on the boundary of Cᵢ to evaluate Eq. 6.

To sum up, we redefine δ(L_{F}, R_{F|i}) as follows.

$$δ ( {L}_{F} , {R}_{F \vert i} ) = \{ \begin{matrix}{δ}_{1} ( {L}_{F} , {R}_{F \vert i} ) & if & ∃ F \\ {δ}_{2} ( {L}_{F} , {R}_{F \vert i} ) & else if & ∃ {C}_{i} ∧ ∄ F \\ - ∞ & else & \end{matrix} \qquad ( 7 )$$

Even though this formulation gives a lower bound of Eq. 2, note that when the original function evaluates to 0, this relaxation also evaluates to 0. Therefore, we can still use sigmoid function of Eq. 4 to get differentiable inclusion score. Note that in these relaxations, we need to obtain every Power cell Cᵢ, which can be achieved by computing WDT for current point configuration.

### C. Methods

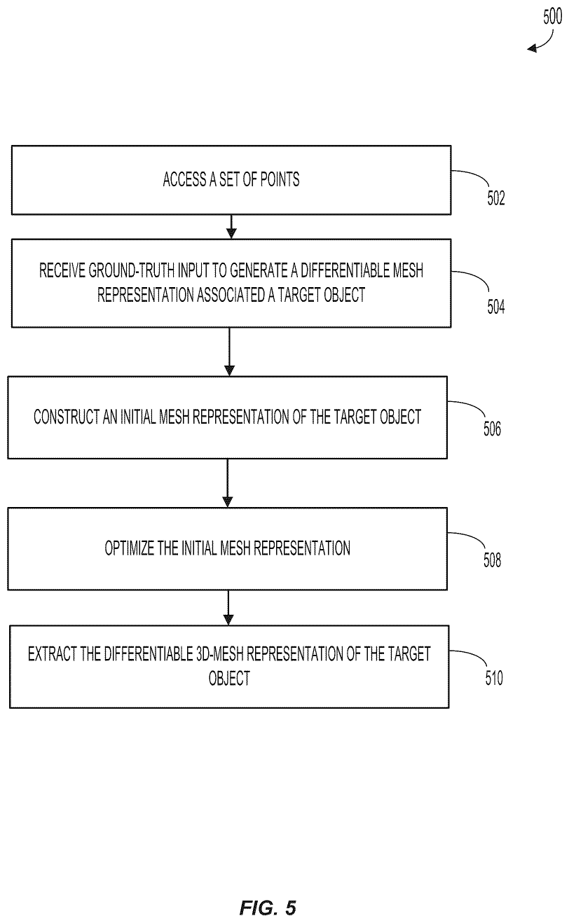

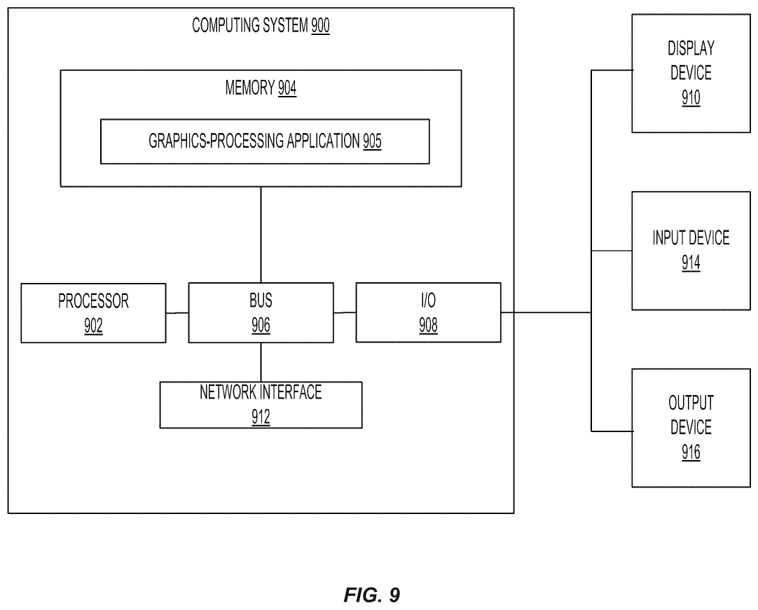

FIG. 5 shows an illustrative example of a process 500 for generating a differentiable mesh representation of an image object, in accordance with some embodiments. For illustrative purposes, the process 500 is described with reference to the components illustrated in FIG. 2, though other implementations are possible. For example, the program code for the graphics-processing application 202 of FIG. 2, is executed by one or more processing devices to cause a server system (e.g., the computing device 902 of FIG. 9) to perform one or more operations described herein.

At step 502, the graphic-processing application accesses a set of points. In some instances, each point identifies a particular location within one or more regions (e.g., a grid) within a three-dimensional (3D) space. Each point is assigned with a weighted value, in which the weighted value indicates a likelihood of whether the point exists within a differentiable mesh representation.

The points can be distributed randomly within the one or more regions, in which the differentiable mesh representation can be generated based on simplices that are formed based on the random distribution of the points. In some instances, the set of points are initialized based on one or more sample points, in which the differentiable mesh representation can be generated based on simplices that are formed based on the sampled distribution. The sampled distribution of points can be advantageous in reducing the computational time and cost for generating the differentiable mesh representation.

At step 504, the graphic-processing application receives ground-truth input to generate the differentiable mesh representation associated a target object. In some instances, the differentiable mesh representation corresponds to a two-dimensional or three-dimensional mesh representation of the target object. In some instances, the ground-truth input includes a set of multi-view images depicting the target object. The set of multi-view images include images captured from different angles or perspectives around the target object.

Additionally or alternatively, the ground-truth input includes point cloud data that represents the target object. The point cloud data includes a collection of data points in a 3D coordinate system, in which each point represents a specific location on the surface of the target object. The points of the point cloud data are configured to identify spatial information, such as X, Y, and Z coordinates, that describe the target object's shape and structure.

At step 506, the graphic-processing application constructs an initial mesh representation of the target object. The initial mesh representation is constructed to represent one or more surfaces of the target object and includes a network of interconnected vertices, edges, and simplices. The simplices, typically triangular or quadrilateral, form shape components that define the shape and appearance of the target object. As an illustrative example, the vertices represent points in 3D space, and the edges connect the vertices to form the target object's surface. The mesh representations are thus used to approximate the geometry of target object and is configured to be used for rendering 3D models in simulations, animations, video games, and virtual environments. The mesh representations also allow for efficient storage and manipulation of 3D shapes, enabling detailed visualizations and modifications of the target object's structure.

In some instances, the graphic-processing application constructs the initial mesh representation by generating a plurality of simplices based on the weighted values of the points. In some instances, each simplex of the plurality of simplices is assigned with an existence probability value that represents a likelihood of points of the simplex existing within the differentiable mesh representation. In some instances, the graphic-processing application generates the plurality of simplices by applying a weighted Delaunay triangulation (WDT) function to the set of points.

At step 508, the graphic-processing application optimizes the initial mesh representation by adjusting the existence probability values based on a comparison between the initial mesh representation with the ground-truth input. The graphic-processing application can optimize initial mesh representation without accessing volumetric information associated with the ground-truth input.

To adjust the weighted values, the graphic-processing application determines a reconstruction loss between the initial mesh representation with the ground-truth input. The graphic-processing application modifies the weighted values based on the reconstruction loss. The graphic-processing application then adjusts the existence probability value based on the adjusted weighted values. In some instances, the graphic-processing application utilizes a differentiable existence function allows for adjusting the weighted values. Examples of metrics used for reconstructive loss include Chamfer distance, Hausdorff distance, Mean Squared Error (MSE), Intersection over Union (IoU), and Structural Similarity Index (SSIM).

At step 510, the graphic-processing application extracts a differentiable mesh representation of the target object by selecting a set of simplices of the plurality of simplices associated with the initial mesh representation, wherein the set of simplices include adjusted existence probability values that exceed a threshold value. In some instances, the threshold value is selected from one of 0.1, 0.2, 0.3, 0.4, 0.5, 0.6, 0.7, 0.8, 0.9, or 1.0. For example, each simplex of the set of simplices include adjusted existence probability values that exceed the threshold value of 0.5. In some instances, the optimizing and extracting steps are iteratively performed until the differentiable mesh representation is refined to accurately represent the target object (e.g., the yellow dress 108 of FIG. 1).

In some instances, the differentiable mesh representation includes one or more non-convex shapes that represent one or more portions of the target object. In some instances, the graphic-processing application extracts the differentiable mesh representation includes reducing one or more simplices from the set of simplices of the differentiable mesh representation based on a face-simplification loss function. Process 500 terminates thereafter.

The differentiable mesh representation can be utilized to train various machine-learning models by leveraging the corresponding weight values. As described herein, existing techniques include triangular meshes that represent surfaces with binary values (i.e., edges and faces exist or do not exist), making such meshes unsuitable for gradient-based optimization. The differentiable mesh representation is advantageous as it assigns probabilities (e.g., the weighted values) to simplex combinations within the mesh, enabling continuous representation. This allows the machine-learning models to compute gradients effectively and thus facilitate training of the machine-learning models. The differentiable nature of the differentiable mesh representation is particularly advantageous for generative AI tasks. The differentiable mesh representation supports reconstruction from point clouds or images without relying on predefined connectivity, thus enabling creation of diverse and complex 3D shapes (e.g., non-convex shapes).

### II. Experimental Data

In this section, we provide experimental results that show the efficacy of our approach. First, when we are given points and their connectivity information, we optimize the point attributes to restore the connectivity. With this experiment, we directly prove the differentiability of our design and show that our representation preserves most of the connectivity and sharp features of the ground truth mesh, even if we store only point features, which shows the representation power of our design. Next, we conduct experiments about 3D reconstruction to show how our differentiable formulation can be used in downstream applications. To be specific, we demonstrate 3D reconstruction from point clouds and multi-view images.

TABLE 1
Statistics for Experiment 1. For each of the model, we computed the
recovery ratio (RE) and false positive ratio (FP). As the shape becomes
more complex, it becomes harder to preserve every information.

| — | Rabbit | Dragon | Buddha | Knot | Bucky |
|---|---|---|---|---|---|
| # vertex | 453 | 5205 | 7108 | 10240 | 19440 |
| # face | 948 | 11102 | 15536 | 20480 | 39240 |
| RE | 99.78% | 99.72% | 99.64% | 99.95% | 98.65% |
| FP | 0.00% | 0.55% | 0.84% | 1.02% | 6.01% |

We implemented our main algorithm for computing face existence likelihoods for a set of faces in CUDA [Nickolls et al. 2008]. Since we need to compute WDT before running the CUDA algorithm, we used WDT implementation of CGAL [Jamin et al. 2023]. On top of that, we implemented the rest of logic with Pytorch [Paszke et al. 2017]. All of the experiments were run on a system with AMD EPYC 7R32 CPU and Nvidia A10 GPU. Note that in every experiment, we resized the models to fit in a unit sphere.

### A. Representation Capacity

In this experiment, our goal is to demonstrate that our representation can accurately depict 3D meshes of various topologies, shapes, and resolutions, while maintaining their sharp features. We achieve this by transforming an existing ground truth mesh into our representation, assuming known target connectivity.

Our goal is to optimize a given mesh with points [symbol] and faces [symbol] , ensuring that [symbol] remains integral. To this end, we assign a weight of 1 to each point in [symbol] and set their η value (distance to the surface) to 0. This acknowledges their established role as mesh points. Additionally, we allow minor position adjustments for these points (up to 0.5% of the model size) to improve connectivity, considering not all meshes are ideally structured for our method.

The optimization focuses on including all faces in [symbol] in the final mesh, while excluding faces in [symbol] , which consist of points in [symbol] but are not part of [symbol] . Our loss function is tailored to maximize inclusion of [symbol] and exclusion of [symbol] .

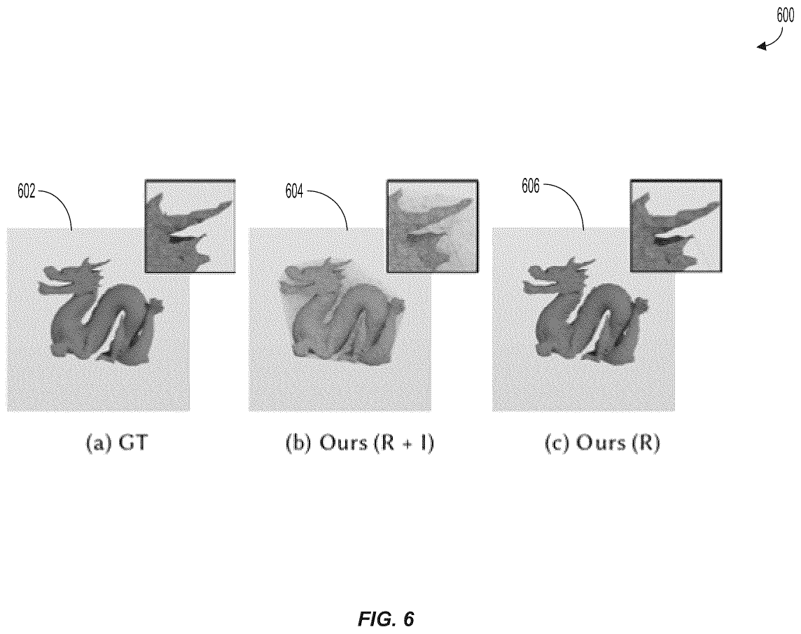

FIG. 6 shows example differentiable mesh representations 600 generated from a ground-truth input depicting a dragon image, according to some embodiments. For given ground truth mesh 602, we can convert it into the differentiable mesh representation 604 while preserving most of the connectivity information, in which yellow faces indicate imaginary part. We can see most of the geometric details, such as sharp edges, are preserved in the differentiable mesh representation 606, while minimizing number of undesirable faces.

FIG. 6 thus shows a comparison between the original and reconstructed Dragon model meshes. The reconstruction (e.g., differentiable mesh representations 604 and 606) retains most details, including sharp edges, but also introduces a thin, undesirable face, as highlighted in the close-up view. Table 1 presents statistics for various models, including vertex and face counts, recovery ratio of desired faces, and false positive ratio for undesired faces. The results indicate effective connectivity restoration, particularly in models with under 10K vertices, where the false positive ratio is below 1%. However, for more complex models like the Bucky, where long, thin triangles are prevalent, the false positive ratio increases to 6%. Additional renderings can be seen in Figure ??. These findings suggest prioritizing the minimization of geometric reconstruction loss (e.g., Chamfer distance or rendering loss) over exact connectivity restoration in mesh reconstruction.

### B. Mesh Reconstruction

In our experiment, we aim to reconstruct a mesh from partial geometric data, such as unoriented point clouds or multi-view images. We use Chamfer distance loss or rendering loss for mesh reconstruction from these partial observations.

TABLE 2
Statistics for point cloud reconstruction. We show
Chamfer distance (10⁻³) to the ground truth mesh
and the number of faces of each reconstruction.

| | | | |
|---|---|---|---|
| — | Ours | NDC | PSR |

| | | | | | | |
|---|---|---|---|---|---|---|
| Bigvegas | 4.98 | (10K) | NA | (15K) | 5.58 | (137K) |
| Bowls | 4.20 | (12K) | NA | (11K) | 5.45 | (110K) |
| Plant | 6.76 | (7K) | NA | (27K) | 98.68 | (484K) |
| Dress | 5.11 | (8K) | NA | (25K) | 14.49 | (238K) |
| Buddha | 5.25 | (7K) | NA | (28K) | 5.16 | (195K) |
| Mousey | 5.05 | (9K) | NA | (20K) | 5.02 | (217K) |
| Raspberry | 7.10 | (14K) | NA | (27K) | 50.19 | (372K) |

In this task, initialization plays a key role terms of convergence speed and quality. Starting with known points on the geometry, not necessarily mesh vertices, enhances accuracy and speed. If we have sample points to initialize our mesh, we use the initialization method from Amenta et al. (1998) (Appendix ??). This approach is also relevant in coarse-to-fine reconstruction without those initial sample points, where we begin with random initialization (Appendix ??).

For point cloud reconstruction, we start with 100K points sampled from the true mesh, using 3% (3K) for initialization. In multi-view image reconstruction, we initialize with either 3K sample points or use a coarse-to-fine strategy. These sample points are realistic in real-world applications, obtainable through techniques like Structure from Motion (SfM) (Snavely et al., 2006).

### 1. Point Cloud

In our study, mesh reconstruction involves minimizing the Chamfer distance between 100K sample points from our model and a given point set [symbol] ∈ [symbol] .

We compared our approach with the Screened Poisson Surface Reconstruction (PSR) [Kazhdan and Hoppe 2013] and Neural Dual Contouring (NDC) [Chen et al. 2022a]. PSR was implemented using MeshLab [Cignoni et al. 2008], and for NDC, we used a grid size of 64, so that it produces similar number of faces as ours. However, NDC's Chamfer distance to the original mesh couldn't be measured due to its different output scale.

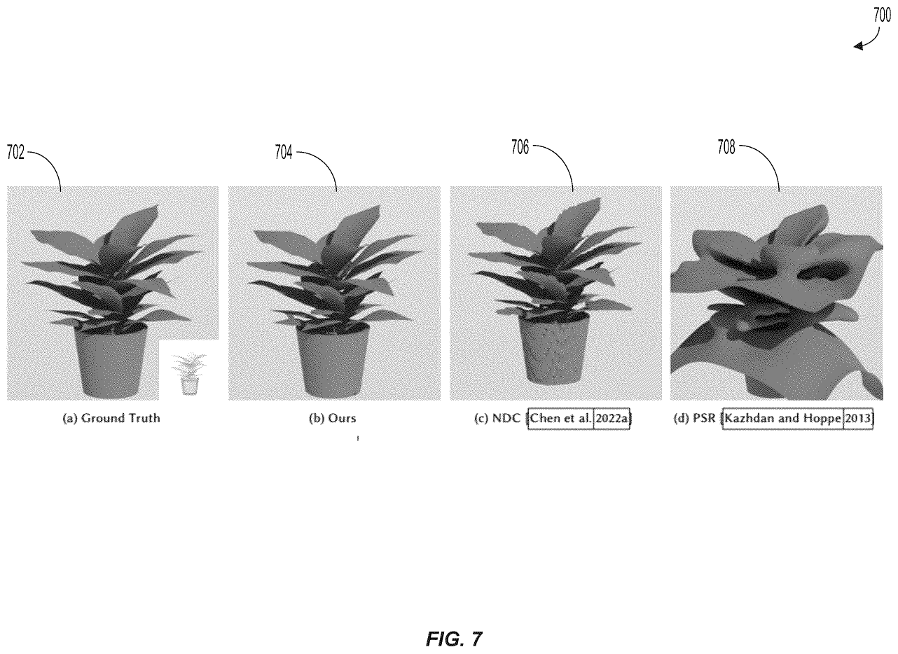

FIG. 7 shows a comparison of images 700 between a differentiable mesh representation and other mesh representations generated from point cloud data, according to some embodiments. For a given point cloud 702 sampled from ground truth mesh, the differentiable mesh representation 704 successfully restores the original shape without losing much detail. By contrast, NDC's mesh 706 is largely affected by the grid size it uses, which results in step-like patterns in its output. In addition, PSR mesh representation 708 completely fails because it cannot process open surfaces depicted by the leaves.

As shown in the reconstruction results alongside the ground truth, our method consistently captures the overall geometry of various models. PSR excels in closed surfaces but struggles with open ones. NDC, while handling open surfaces, introduces artifacts on smooth surfaces due to grid resolution. Quantitatively, our method performs comparably to PSR for closed surfaces and significantly better for open surfaces (Table 2). Notably, our approach produces more compact meshes than PSR or NDC, maintaining detail without needing an extra decimation step.

### 2. Multi-View Images

In this experiment, we reconstruct 3D mesh that aligns with the given set of images taken from multiple viewpoints. The overall framework is same as that of previous section, where the only difference is that we use rendering loss in this task. Specifically, we use diffuse and depth rendering captured at 64 viewpoints of the ground truth mesh for reconstruction.

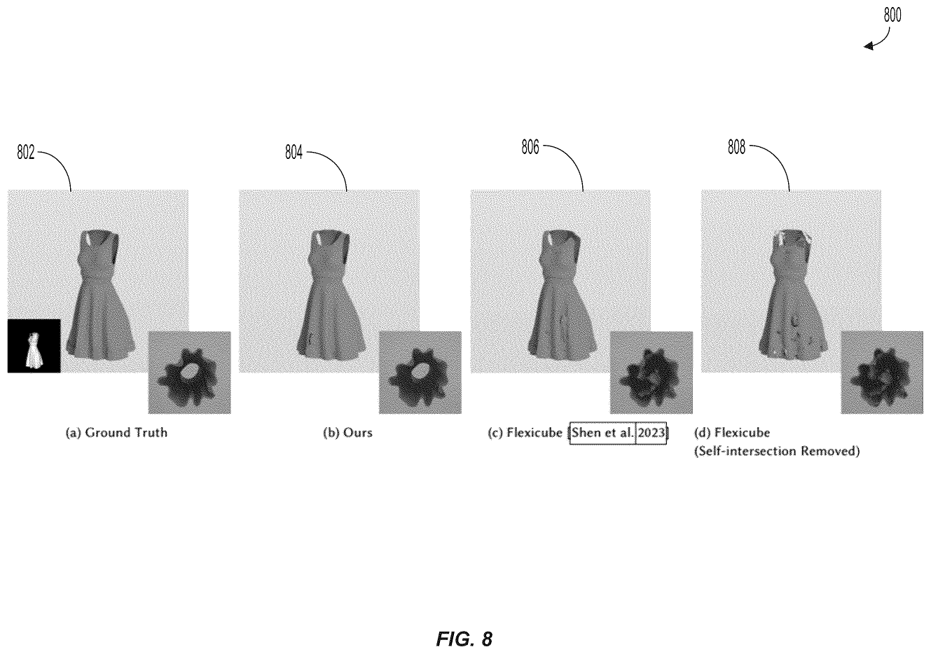

In this experiment, we compared our approach with Flexicube [Shen et al. 2023], which directly produces mesh of varying geometric topology for given visual inputs. In FIG. 8, we present visual renderings of reconstruction results using our method, which uses random initialization, and Flexicube, along with ground truth mesh. When it comes to Dress and Plant model, we captured the reconstructed meshes from different view points to help understanding.

FIG. 8 shows a comparison of images 800 between a differentiable mesh representation and other mesh representations generated based on multi-view images, according to some embodiments. Based on the multi-view images 802, the differentiable mesh representation 804 recovers overall topology of dress, with small artifacts. In contrast, Flexicube meshes 806 and 808 show several false internal structures and self-intersections, which stems from its volumetric formulation.

As shown in FIG. 8, we can observe that our method reconstructs the target geometry generally well, with small artifacts. On the contrary, since Flexicube is grounded in volumetric approach, we can see that it generates lots of false inner structures in Dress and Plant model, and also generates lots of self-intersecting faces across every model, because it strives to approximate open surfaces with thin volumes.

To validate the visual observations, we also computed Chamfer distance to the ground truth mesh model for the reconstructed meshes (Table 3). In the table, we can see that our method using random initialization gives comparable or better results than Flexicube for Bowls and Dress models, but not for the others. Even though Chamfer distance does not reflect self-intersections, this result is mainly because we do not have any geometric constraints to remove faces floating inside our mesh yet—in this respect, Chamfer distance loss is much better supervision loss than rendering loss in our case. We can mitigate this issue by initializing our mesh with 3K sample points, which performs much better than random initialization. Also see FIG. 9 to learn how the result from sample points can help reconstruction visually. This observation tells us that even though our method is pretty versatile, we need some additional measures to enforce minimum constraints on the geometry that we generate.

TABLE 3
Statistics for multi-view reconstruction. We show Chamfer distance
(10⁻³) to the ground truth mesh. For our method, we used
two different initialization methods (Random, Sample points).

| — | Ours (R) | Ours (S) | Flexicube |
|---|---|---|---|
| Bigvegas | 45.31 | 8.22 | 7.06 |
| Bowls | 6.04 | 5.57 | 6.03 |
| Plant | 35.59 | 10.31 | 31.19 |
| Dress | 7.65 | 8.35 | 27.66 |
| Buddha | 39.80 | 10.73 | 6.50 |
| Mousey | 52.12 | 8.86 | 5.77 |
| Raspberry | 18.44 | 11.36 | 17.70 |

### C. Conclusion

We presented a new 3D mesh representation based on WDT. We introduced a differentiable formulation for evaluating the existence likelihood of a set of faces for the given weighted points, and showed that we can use it to reconstruct meshes from point clouds or multi-view images. Experiments showed that our method can reconstruct meshes of various complex shapes and topologies, regardless of closed and open surfaces, when enough supervision is given.

### III. Example Systems

Any suitable computing system or group of computing systems can be used for performing the operations described herein. For example, FIG. 9 depicts a computing system 900 that can implement any of the computing systems or environments discussed above. In some embodiments, the computing system 900 includes a processing device 902 that executes the graphic-processing application 905, a memory that stores various data computed or used by the graphic-processing application 905, an input device 914 (e.g., a mouse, a stylus, a touchpad, a touch-screen, etc.), and an output device 916 that presents output to a user (e.g., a display device that displays graphical content generated by graphic-processing application 905). For illustrative purposes, FIG. 9 depicts a single computing system on which the graphic-processing application 905 is executed, and the input device 914 and output device 916 are present. But these applications, datasets, and devices can be stored or included across different computing systems having devices similar to the devices depicted in FIG. 9.

The example of FIG. 9 includes a processing device 902 communicatively coupled to one or more memory devices 904. The processing device 902 executes computer-executable program code stored in a memory device 904, accesses information stored in the memory device 904, or both. Examples of the processing device 902 include a microprocessor, an application-specific integrated circuit (“ASIC”), a field-programmable gate array (“FPGA”), or any other suitable processing device. The processing device 902 can include any number of processing devices, including a single processing device.

The memory device 904 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions could include processor-specific instructions generated by a compiler or an interpreter from code written in any suitable computer-programming language, including, for example, C, C++, C#, Visual Basic, Java, Python, Perl, JavaScript, and ActionScript.

The computing system 900 could also include a number of external or internal devices, such as a display device 910, or other input or output devices. For example, the computing system 900 is shown with one or more input/output (“I/O”) interfaces 908. An I/O interface 908 can receive input from input devices or provide output to output devices. One or more buses 906 are also included in the computing system 900. Each bus 906 communicatively couples one or more components of the computing system 900 to each other or to an external component.

The computing system 900 executes program code that configures the processing device 902 to perform one or more of the operations described herein. The program code includes, for example, code implementing the document-processing application 102 or other suitable applications that perform one or more operations described herein. The program code can be resident in the memory device 904 or any suitable computer-readable medium and can be executed by the processing device 902 or any other suitable processor. In some embodiments, all modules in the graphic-processing application 905 are stored in the memory device 904, as depicted in FIG. 9. In additional or alternative embodiments, one or more of these modules from the graphic-processing application 905 are stored in different memory devices of different computing systems.

In some embodiments, the computing system 900 also includes a network interface device 912. The network interface device 912 includes any device or group of devices suitable for establishing a wired or wireless data connection to one or more data networks. Non-limiting examples of the network interface device 912 include an Ethernet network adapter, a modem, and/or the like. The computing system 900 is able to communicate with one or more other computing devices (e.g., a computing device that receives inputs for document-processing application 102 or displays outputs of the document-processing application 102) via a data network using the network interface device 912.

An input device 914 can include any device or group of devices suitable for receiving visual, auditory, or other suitable input that controls or affects the operations of the processing device 902. Non-limiting examples of the input device 914 include a touchscreen, stylus, a mouse, a keyboard, a microphone, a separate mobile computing device, etc. An output device 916 can include any device or group of devices suitable for providing visual, auditory, or other suitable sensory output. Non-limiting examples of the output device 916 include a touchscreen, a monitor, a separate mobile computing device, etc.

Although FIG. 9 depicts the input device 914 and the output device 916 as being local to the computing device that executes the document-processing application 102, other implementations are possible. For instance, in some embodiments, one or more of the input device 914 and the output device 916 include a remote client-computing device that communicates with the computing system 900 via the network interface device 912 using one or more data networks described herein.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method comprising:
accessing a set of points, wherein each point identifies a particular location within one or more regions within a three-dimensional space, and wherein each point is assigned with a weighted value;
receiving ground-truth input to generate a differentiable mesh representation associated a target object;
constructing an initial mesh representation of the target object by generating a plurality of simplices based on the weighted values of the points, wherein each simplex of the plurality of simplices is assigned with an existence probability value that represents a likelihood of points of the simplex existing within the differentiable mesh representation;
optimizing the initial mesh representation by iteratively adjusting the existence probability values based on a comparison between the initial mesh representation with the ground-truth input; and
extracting the differentiable mesh representation of the target object by selecting a set of simplices of the plurality of simplices associated with the initial mesh representation, wherein the set of simplices include adjusted existence probability values that exceed a threshold value.

2. The method of claim 1, wherein the ground-truth input includes a set of multi-view images depicting the target object or point cloud data that represents the target object.

3. The method of claim 1, wherein adjusting the weighted values of the plurality of simplices includes:
determining a reconstruction loss between the initial mesh representation with the ground-truth input;
modifying the weighted values based on the reconstruction loss; and
adjusting the existence probability values based on the modified weighted values.

4. The method of claim 1, wherein the differentiable mesh representation includes one or more non-convex shapes that represent one or more portions of the target object.

5. The method of claim 1, wherein generating the plurality of simplices includes applying a weighted Delaunay triangulation (WDT) function to the points of the set.

6. The method of claim 1, wherein extracting the differentiable mesh representation includes reducing one or more simplices from the set of simplices of the differentiable mesh representation based on a face-simplification loss function.

7. The method of claim 1, wherein the initial mesh representation is optimized without accessing volumetric information associated with the ground-truth input.

8. A system comprising:
one or more processors; and
a non-transitory computer-readable medium storing instructions that when executed by the one or more processors, cause the one or more processors to perform operations including:
accessing a differentiable mesh representation associated a target object, wherein the differentiable mesh representation was generated by:
accessing a set of points, wherein each point identifies a particular location within one or more regions within a three-dimensional space, and wherein each point is assigned with a weighted value;
constructing an initial mesh representation of the target object by generating a plurality of simplices based on the weighted values of the points, wherein each simplex of the plurality of simplices is assigned with an existence probability value that represents a likelihood of points of the simplex existing within the differentiable mesh representation;
optimizing the initial mesh representation by iteratively adjusting the existence probability values based on a comparison between the initial mesh representation with a ground-truth input associated with the target object; and
extracting the differentiable mesh representation of the target object by selecting a set of simplices of the plurality of simplices associated with the initial mesh representation, wherein the set of simplices include adjusted existence probability values that exceed a threshold value; and
training a machine-learning model to generate one or more images depicting the target object, wherein the machine-learning model is trained using the differentiable mesh representations.

9. The system of claim 8, wherein the ground-truth input includes a set of multi-view images depicting the target object or point cloud data that represents the target object.

10. The system of claim 8, wherein adjusting the weighted values of the plurality of simplices includes:
determining a reconstruction loss between the initial mesh representation with the ground-truth input;
modifying the weighted values based on the reconstruction loss; and
adjusting the existence probability values based on the modified weighted values.

11. The system of claim 8, wherein the differentiable mesh representation includes one or more non-convex shapes that represent one or more portions of the target object.

12. The system of claim 8, wherein generating the plurality of simplices includes applying a weighted Delaunay triangulation (WDT) function to the points of the set.

13. The system of claim 8, wherein extracting the differentiable mesh representation includes reducing one or more simplices from the set of simplices of the differentiable mesh representation based on a face-simplification loss function.

14. The system of claim 8, wherein the initial mesh representation is optimized without accessing volumetric information associated with the ground-truth input.

15. A non-transitory computer-readable medium storing instructions that when executed by one or more processors, cause the one or more processors to perform operations including:
accessing a set of points, wherein each point identifies a particular location within one or more regions within a three-dimensional space, and wherein each point is assigned with a weighted value;
receiving ground-truth input to generate a differentiable mesh representation associated a target object;
constructing an initial mesh representation of the target object by generating a plurality of simplices based on the weighted values of the points, wherein each simplex of the plurality of simplices is assigned with an existence probability value that represents a likelihood of points of the simplex existing within the differentiable mesh representation;
optimizing the initial mesh representation by iteratively adjusting the existence probability values based on a comparison between the initial mesh representation with the ground-truth input; and
extracting the differentiable mesh representation of the target object by selecting a set of simplices of the plurality of simplices associated with the initial mesh representation, wherein the set of simplices include adjusted existence probability values that exceed a threshold value.

16. The non-transitory computer-readable medium of claim 15, wherein the ground-truth input includes a set of multi-view images depicting the target object or point cloud data that represents the target object.

17. The non-transitory computer-readable medium of claim 15, wherein adjusting the weighted values of the plurality of simplices includes:
determining a reconstruction loss between the initial mesh representation with the ground-truth input;
modifying the weighted values based on the reconstruction loss; and
adjusting the existence probability values based on the modified weighted values.

18. The non-transitory computer-readable medium of claim 15, wherein the differentiable mesh representation includes one or more non-convex shapes that represent one or more portions of the target object.

19. The non-transitory computer-readable medium of claim 15, wherein generating the plurality of simplices includes applying a weighted Delaunay triangulation (WDT) function to the points of the set.

20. The non-transitory computer-readable medium of claim 15, wherein extracting the differentiable mesh representation includes reducing one or more simplices from the set of simplices of the differentiable mesh representation based on a face-simplification loss function.
